(19) United States
(12) Patent Application Publication
(10) Pub. No.: US 2016/0177430 A1
(43) Pub. Date: Jun. 23, 2016

(54) ZR-GROUP AMORPHOUS ALLOY COMPOSITION

(71) Applicant: KOREA INSTITUTE OF INDUSTRIAL TECHNOLOGY, Chungcheongnam-do (KR)

(72) Inventors: Seungyong SHIN, Seoul (KR); Kyoungil MOON, Incheon (KR); Juhyun SUN, Incheon (KR); Changhun LEE, Incheon (KR)

(73) Assignee: Korea Institute of Industrial Technology, Chungcheongnam-do (KR)

(21) Appl. No.: 14/787,030

(22) PCT Filed: Jun. 5, 2014
(86) PCT No.: PCT/KR2014/004995

§ 371 Date: Oct. 26, 2015

(30) Foreign Application Priority Data
Apr. 26, 2013 (KR) 10-2013-0046627

(51) Int. Cl. C22C 45/10; B22D 21/06; H01M 8/0208; B22D 21/00

(52) U.S. Cl. CPC C22C 45/10; B22D 21/005; B22D 21/06; H01M 8/0208

(57) ABSTRACT

The purpose of the present invention is to provide a highly corrosion-resistant Zr-group amorphous alloy composition containing a higher Zr content compared to existing amorphous alloys, and comprising only commercial metal elements, and thereby has superior industrial and economic utility and is easily rendered practical. According to one aspect of the present invention, provided is the Zr-group amorphous alloy composition comprising: 67-78 atomic percent of Zr; 4-13 atomic percent of Al and/or Co; 15-24 atomic percent of Cu and/or Ni, wherein glass forming ability of the Zr-group amorphous alloy composition is at least 0.5 mm.

### TECHNICAL FIELD

The present invention is related to an amorphous alloy composition having high corrosion resistance, in particular to a Zr-group amorphous alloy composition having an amorphous forming ability equal to or more than 0.5 mm.

### BACKGROUND ART

An amorphous alloy has high strength property equal to or more than 2 GPa, and other superior properties such as wear resistance, corrosion resistance, fracture toughness, compared with conventional crystalline metal materials

Currently, a multi element sputtering target is required in the fields of semiconductor manufacturing process, a microstructure manufacturing process such as MEMS, a coating forming process for molds and vehicle parts for increasing wear resistance. The multi element sputtering target is formed by using an amorphous alloy having Zr as a base material and being capable to form high hardness nitride by reaction with reactive nitrogen gas. In addition, as the demand for electric vehicles increases, amorphous materials can be applied in order to enhance corrosion resistance of a metal bipolar plate used in a polymer electrolyte fuel cell. The bipolar plate is initially made of graphite, but metallic bipolar plate is researched in order to improve economics, strength, and electrical conductivity. However, the metallic bipolar plate has a weakness of low corrosion resistance against operation environments of fuel cells. Accordingly, various attempts to increase corrosion resistance of a bipolar plate are performed. For example, amorphous alloy ribbons are used to form bipolar plate or an amorphous film is coated on a metallic plate. It is known that Zr-group amorphous alloys have a high forming ability. For example, it is reported that Zr—Al—Ni—Cu system alloy has an amorphous forming ability of equal to or more than 10 mm. However, the reported Zr-group amorphous alloys has equal to or less than 65 atomic % of Zr, and thus the contents of Ni and Cu therein has an amorphous forming ability in the relatively high composition range. Therefore, an amorphous alloy having high Zr content and low Ni or Cu content is required in order to increases wear resistance and corrosion resistance.

### DETAILED DESCRIPTION OF THE INVENTION

### Technical Problem

The purpose of the present invention is to provide a highly corrosion-resistant Zr-group amorphous alloy composition containing a higher Zr content compared to existing amorphous alloys, and comprising only commercial metal elements, and thereby has superior industrial and economic utility and is easily rendered practical. However, this purpose is exemplary, and the present invention is not limited thereto.

### Technical Solution

According to one aspect of the present invention, a Zr-group amorphous alloy composition is provided. The Zr-group amorphous alloy composition includes: 67 atomic % through 78 atomic % of Zr; 4 atomic % through 13 atomic % of one or more selected from Al and Co; and 15 atomic % through 24 atomic % of one or more selected from Cu and Ni. An amorphous forming ability thereof is equal to or more than 0.5 mm.

The Zr-group amorphous alloy composition may include: 67 atomic % through 78 atomic % of Zr; 4 atomic % through 12 atomic % of Co; and 15 atomic % through 24 atomic % of one or more selected from Cu and Ni.

The Zr-group amorphous alloy composition may include: 67 atomic % through 78 atomic % of Zr; 3 atomic % through 10 atomic % of Al; 2 atomic % through 9 atomic % of Co; and 17 atomic % through 23 atomic % of Cu.

the Zr-group amorphous alloy composition may be capable to obtain an amorphous ribbon having casting thickness in the range of 20 μm through 100 μm when the melt of the alloy composition is casted with a cooling rate in the range of 10⁴ K/sec through 10⁶ K/sec.

The Zr-group amorphous alloy composition may be an amorphous alloy powder or a nano-crystalline alloy powder. The Zr-group amorphous alloy composition may be a foil typed amorphous alloy ribbon or nano-crystalline alloy ribbon. The Zr-group amorphous alloy composition may be an amorphous alloy casting material or a nano-crystalline alloy casting material.

According to another aspect of the present invention, a bipolar plate for a fuel cell is provided. The fuel cell is manufactured by using an amorphous ribbon having the same composition as the above described alloy composition.

### Advantageous Effects

According to embodiments of the present invention, a Zr-group amorphous alloy composition having an amorphous forming ability and wide super cooled liquid region can be provided. Furthermore, thermal/mechanical stability of the target composed of a crystalline alloy formed by heating the Zr-group amorphous alloy composition in a predetermined temperature range is significantly increased, and thus the target is not drastically broken during the sputtering process, thereby stably performing sputtering process. In addition, since the target has very uniform microstructure, composition difference between the target and the thin film due to the difference in sputtering yields in the target of multi element system can be significantly reduced and the uniformity of composition inside of the thin film can be obtained.

In addition, when amorphous ribbons composed of the amorphous alloy composition is applied to a bipolar plate in a polymer electrolyte fuel cell stack, the bipolar plate may have excellent corrosion resistance, compared with metallic plates. However, the present invention is not limited to these effects.

### DESCRIPTION OF THE DRAWINGS

FIG. 1a shows a ternary phase diagram of Zr—Co—(Ni,Cu) system showing a region in which bulk amorphous formation equal to or more than 0.5 mm is observed in an alloy composition, according to an embodiment of the present invention. FIG. 1b shows a ternary phase diagram of Zr—(Al, Co)—Cu system, according to an embodiment of the present invention.

FIG. 2 shows X-ray diffraction analysis results for showing an amorphous forming ability, according to an embodiment of the present invention.

FIG. 3 shows DSC analysis results for showing crystallization properties, according to an embodiment of the present invention.

FIG. 4 shows an exterior shape of a sputtering target formed by using the alloy composition of the embodiment 2 of the present invention.

FIG. 5a through FIG. 5d show electron microscopy observation results of regions near indentation marks after crack generation test for the Zr-group amorphous alloy composition after annealing, according to an embodiment of the present invention.

FIG. 6a through FIG. 6d show electron microscopy observation results of microstructures of the crystalline alloy targets formed by using the Zr-group amorphous alloy composition, according to an embodiment of the present invention.

FIG. 7 is a photograph of an amorphous alloy ribbon having 70 μm thickness formed by using the composition of embodiment 15 of the present invention.

FIG. 8 shows potentiodynamic polarization test results of amorphous ribbons formed by using the Zr-group amorphous alloy composition under a fuel cell stack environment, according to an embodiment of the present invention.

### MODE OF INVENTION

Reference will now be made in detail to exemplary embodiments, examples of which are illustrated in the accompanying drawings. However, exemplary embodiments are not limited to the embodiments illustrated hereinafter, and the embodiments herein are rather introduced to provide easy and complete understanding of the scope and spirit of exemplary embodiments. In the drawings, the thicknesses of layers and regions are exaggerated for clarity.

The term “amorphous” in the present invention indicates the case having typically known amorphous properties to the field of the art, such as a entirely and mainly amorphous structure having a halo type X-ray diffraction pattern. For example, the amorphous include a composition having 100% amorphous structure and also a mixed structure of crystalline (or nano-crystalline) and amorphous until keeping the amorphous properties. The nano-crystalline alloy indicates a metal alloy structure having less than 100 nm average crystal grain size.

In the present invention, the amorphous forming ability (or glass forming ability) is a relative criterion showing a degree of amorphization of an alloy having a predetermined composition with respect to a certain cooling rate. Generally, when an amorphous alloy is formed by a casting method, a cooling rate should be higher than a predetermined level. When a casting method with a low cooling rate, for example copper mold casting method, is used, the composition range for forming an amorphous material is reduced. A rapid solidification process, such as a melt spinning method in which melted alloy is dropped on a rotating copper roll to form a ribbon or a wire rod, can have a very high cooling rate in the range of 10⁴ K/sec through 10⁶ K/sec, thereby expanding the composition range for forming an amorphous material. Therefore, the evaluation for the amorphous forming ability with respect to the composition range is generally related to a relative value according to the cooling rate of the given rapid solidifying process.

Since the amorphous forming ability is dependent of an alloy composition and a cooling rate, and the cooling rate is inversely proportional to a cast thickness [(cooling rate)∝(cast thickness)⁻²], the amorphous forming ability can be relatively quantified by evaluating a critical thickness of a casting material for obtaining an amorphous structure during casting. For example, in the copper mold casting method, the amorphous forming ability can be represented by a critical casting thickness (or diameter for a rod) of any casting material for obtaining an amorphous structure. For example, when a ribbon is formed by the melt spinning method, the amorphous forming ability can be represented by a critical thickness of the ribbon for obtaining an amorphous structure.

In the present invention, the alloy having the amorphous forming ability is an alloy for forming an amorphous ribbon with a casting thickness in the range of 20 μm through 100 μm when a melt of the alloy is casted with a cooling rate in the range of 10⁴ K/sec through 10⁶ K/sec.

The alloy having an amorphous forming ability according to the present invention has three or more elements. For the alloy, the difference in atomic radii of the major elements is more than 12% and the heat of mixing among the major elements is negative.

A Zr-group amorphous alloy composition according to an embodiment of the present invention includes 67 atomic % through 78 atomic % of Zr, 4 atomic % through 13 atomic % of one or more selected from Al and Co, and 15 atomic % through 24 atomic % of one or more selected from Cu and Ni. The amorphous forming ability thereof is equal to or more than 0.5 mm. For example, a Zr-group amorphous alloy composition according to an embodiment of the present invention includes 67 atomic % through 78 atomic % of Zr, 4 atomic % through 12 atomic % of Co, and 15 atomic % through 24 atomic % of one or more selected from Cu and Ni. The amorphous forming ability thereof is equal to or more than 0.5 mm. For example, a Zr-group amorphous alloy composition according to an embodiment of the present invention includes 67 atomic % through 78 atomic % of Zr, 3 atomic % through 10 atomic % of Al, 2 atomic % through 9 atomic % of Co, and 17 atomic % through 23 atomic % of Cu. The amorphous forming ability thereof is equal to or more than 0.5 mm.

A Zr-group amorphous alloy composition according to an embodiment of the present invention includes, for example, 67 atomic % through 78 atomic % of Zr, for example, 67 atomic % through 76 atomic % of Zr, for example, 67.4 atomic % through 75.7 atomic % of Zr, for example, 69.86 atomic % through 75.7 atomic % of Zr, or for example, 70.2 atomic % through 75.7 atomic % of Zr,

In the specification of the present invention, the unit of atomic % means the atomic ratio of a certain atom in the alloy composition thereof

Hereinafter, embodiments will be provided to easily describe the present invention. However, the following embodiments are provided only to understand the spirit of the present invention, but not to limits the present invention.

Table 1 shows alloy compositions, amorphous forming ability (GFA) values, glass transition temperatures (T_{g}), crystallization starting temperatures (Tₓ), super cooled liquid regions (ΔT=Tₓ−T_{g}), solidus line temperatures (Ts), and liquidus line temperatures (T_{L}) of Zr-group amorphous alloy compositions according to embodiments of the present invention. For example, the composition of the amorphous alloy of the embodiment 1 is 67.4 atomic % of Zr, 7 atomic % of Al, 3 atomic % of Co, 22.6 atomic % of Cu. The amorphous alloy is represented as Zr_{67.4}Al₇O₃Cu_{22.6}. (Hereinafter, the composition of the alloy is represented by the same manner.)

The Zr-group amorphous alloy composition in Table 1 can be formed as an amorphous alloy casting material (amorphous alloy bar), amorphous alloy powders, foil-typed amorphous alloy ribbons. The exemplary methods thereof are a rapid solidification process, a mold casting method, a high pressure casting method, an atomizing method, and/or a melt spinning.

For example, the amorphous alloy casting material was formed by melting an alloy button having corresponding composition in Table 1 by using an arc melting method and casting it using a copper mold suction casting method. Generally, the cooling rate of a mold casting method such as the copper mold suction casting method is lower than that of the melt spinning. The alloy having the above composition has an amorphous forming ability defined in the present invention.

The amorphous alloy powders can be formed by the atomizing method. For example, the alloy having the composition in Table 1 was melted by an arc melting method to form alloy buttons. The alloy buttons were melted again by using high frequency energy in a powder manufacturing apparatus, and then the melt is sprayed by argon gas to form the alloy powders.

The foil-typed amorphous alloy ribbons were formed by the melt spinning method. Specifically, elements with a predetermined composition in Table 1 were melted by an arc melting method to form alloy melt. The alloy melt was injected through a nozzle onto a surface of a copper roll with 600 mm diameter rotating 700 rpm and rapidly solidified to form the ribbons.

TABLE 1

| | Alloy | GFA | T_{g} | Tₓ | ΔT | T_{S} | T_{L} |
|---|---|---|---|---|---|---|---|
| Embodiment | Composition | (mm) | (° C.) | (° C.) | (° C.) | (° C.) | (° C.) |
| 1 | Zr_{67.4}Al₇Co₃Cu_{22.6} | 4 | 373.03 | 421.58 | 48.55 | 883.57 | 927.26 |
| 2 | Zr_{71.1}Al₁₂Cu_{16.9} | 1 | 384.70 | 396.55 | 11.85 | 845.71 | 905.92 |
| 3 | Zr_{70.9}Al₁₀Co₂Cu_{17.1} | 1 | 381.54 | 396.91 | 15.37 | 875.02 | 900.60 |
| 4 | Zr_{70.7}Al₁₀Co_{1.5}Mo_{0.5}Cu_{17.3} | 1 | 384.06 | 396.91 | 12.85 | 875.21 | 902.58 |
| 5 | Zr_{70.8}Al₉Co₃Cu_{17.2} | 2 | 369.45 | 404.60 | 35.15 | 872.82 | 900.96 |
| 6 | Zr_{70.7}Al₈Co₄Cu_{17.3} | 1 | 364.65 | 404.18 | 39.53 | 883.91 | 906.43 |
| 7 | Zr_{70.4}Al₅Co₇Cu_{17.6} | 2 | 366.70 | 403.43 | 36.73 | 858.67 | 902.11 |
| 8 | Zr_{70.2}Al₃Co₉Cu_{17.8} | 1 | 360.70 | 392.06 | 31.36 | 843.38 | 915.03 |
| 9 | Zr_{70.5}Al₁₀Si₂Cu_{17.5} | 1 | 401.45 | 449.63 | 48.18 | 851.65 | 927.18 |
| 10 | Zr_{70.8}Al₅Co₅Cu_{19.2} | 1 | 360.36 | 397.45 | 37.09 | 871.75 | 924.13 |
| 11 | Zr₇₁Al₁₃Cu₁₆ | 0.5 | 384.30 | 404.32 | 20.02 | 848.08 | 911.68 |
| 12 | Zr_{70.4}Ni₃Co₆Cu_{20.6} | 1 | 349.76 | 383.62 | 33.86 | 880.15 | 955.01 |
| 13 | Zr_{68.86}Co₁₃Cu_{18.14} | 0.5 | 360.12 | 377.31 | 17.19 | 876.28 | 929.99 |
| 14 | Zr_{75.7}Ni₆Co_{8.6}Cu_{9.7} | 0.5 | 335.73 | 349.06 | 13.33 | 846.57 | 919.70 |
| 15 | Zr_{74.05}Ni₂Co_{4.8}Cu_{19.15} | 0.5 | 331.90 | 348.54 | 16.64 | 853.15 | 960.48 |

The Zr-group amorphous alloy compositions in Table 1 have equal to or more than 0.5 mm of the amorphous forming abilities and super cooled liquid regions (ΔT) in the range of 11.85° C. through 48.55° C. That is, the Zr-group amorphous alloy composition of the present invention has high Zr content, the excellent amorphous forming ability, and a wide ranged super cooled liquid region. The Zr content of the Zr-group amorphous alloy composition is, for example in the range of 67 atomic % through 78 atomic %, for example in the range of 67 atomic % through 76 atomic %, for example in the range of 67.4 atomic % through 75.7 atomic %, for example in the range of 69.86 atomic % through 75.7 atomic %, for example in the range of 70.2 atomic % through 75.7 atomic %.

Referring to the embodiment 1 through the embodiment 3, the embodiment 5 through the embodiment 8, and the embodiment 10 through the embodiment 15 in Table 1, the Zr-group amorphous alloy composition according to the embodiment of the present invention includes 67 atomic % through 78 atomic % of Zr, 4 atomic % through 13 atomic % of one or more selected from Al and Co, and 15 atomic % through 24 atomic % of one or more selected from Cu and Ni. For example, the Zr-group amorphous alloy composition includes 67.4 atomic % through 75.7 atomic % of Zr, 4.8 atomic % through 13 atomic % of one or more selected from Al and Co, and 15.7 atomic % through 23.6 atomic % of one or more selected from Cu and Ni. In this case, the amorphous forming ability is in the range of 0.5 mm through 4 mm.

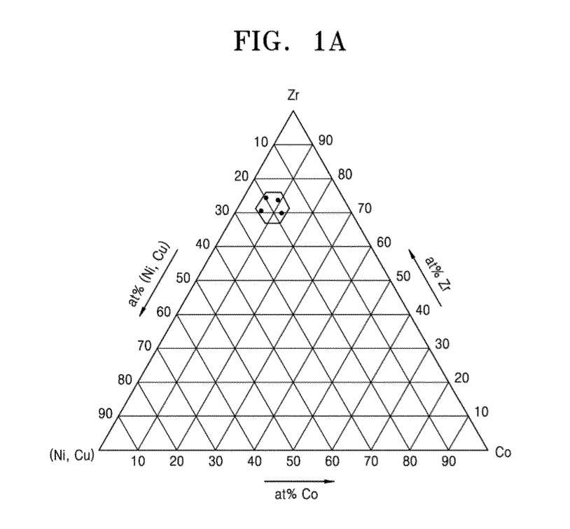

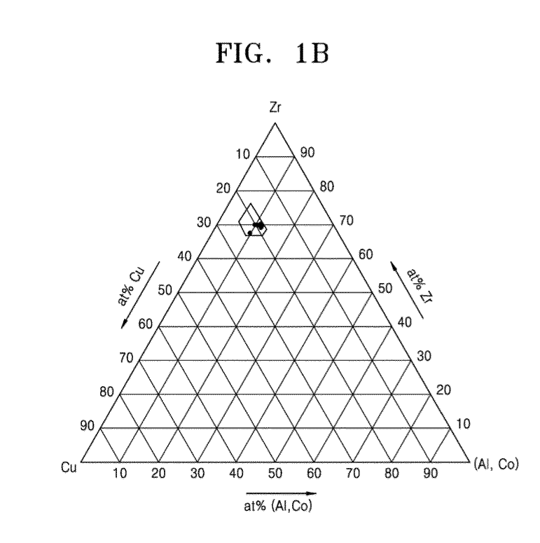

FIG. 1a shows a phase diagram for a Zr-group amorphous alloy of the present invention without Al. When Al is not added, it is known that a sufficient amorphous forming ability and a wide range super cooled liquid region cannot be obtained. However, referring to the embodiment 12 through the embodiment 15 in Table 1, the Zr-group amorphous alloy composition according to the embodiment of the present invention does not include Al. The Zr-group amorphous alloy composition includes, for example, 67 atomic % through 78 atomic % of Zr, 4 atomic % through 12 atomic % of Co, and 15 atomic % through 24 atomic % of one or more selected from Cu and Ni, for example, 69.86 atomic % through 75.7 atomic % of Zr, 4.8 atomic % through 12 atomic % of Co, and 15.7 atomic % through 23.6 atomic % of one or more selected from Cu and Ni. The Zr-group amorphous alloy composition has the amorphous forming ability in the range of 0.5 mm through 1 mm and the super cooled liquid region in the range of 13.33° C. through 33.86° C.

FIG. 1a shows a phase diagram for a Zr—(Al,Co)—Cu amorphous alloy of the present invention. When Ni is not added, it is known that a sufficient amorphous forming ability and a wide range super cooled liquid region cannot be obtained. However, referring to the embodiment 1, the embodiment 3, the embodiment 5 through the embodiment 8, the embodiment 10 in Table 1, the Zr-group amorphous alloy composition according to the embodiment of the present invention is not include Ni. The Zr-group amorphous alloy composition includes, for example, 67 atomic % through 78 atomic % of Zr, 3 atomic % through 10 atomic % of Al, 2 atomic % through 9 atomic % of Co, and 17 atomic % through 23 atomic % of Cu, for example, 67.4 atomic % through 70.9 atomic % of Zr, 3 atomic % through 10 atomic % of Al, 2 atomic % through 9 atomic % of Co, and 17.1 atomic % through 22.6 atomic % of Cu. The Zr-group amorphous alloy composition has the amorphous forming ability in the range of 1 mm through 4 mm and the super cooled liquid region in the range of 15.37° C. through 48.55° C.

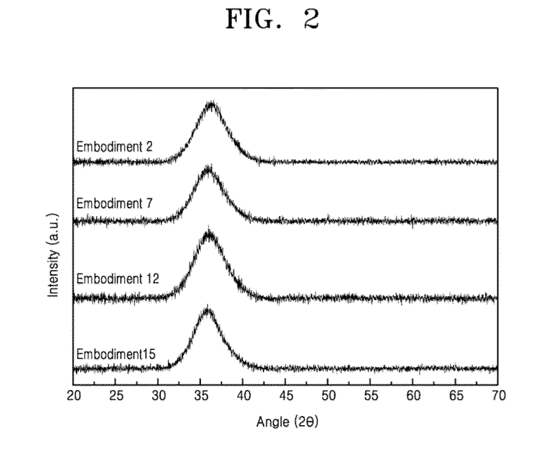

FIG. 2 shows results of the amorphous forming ability of the alloys using X-ray diffraction, according to an embodiment of the present invention.

Referring to FIG. 2, for each of the Zr-group amorphous alloy compositions of the embodiment 2, the embodiment 7, the embodiment 12 and the embodiment 15 in Table 1, a broad peak typically appeared in an amorphous phase was observed, but a crystalline peak (sharp peak) was not observed. A broad peak was observed for each of all embodiments in Table 1.

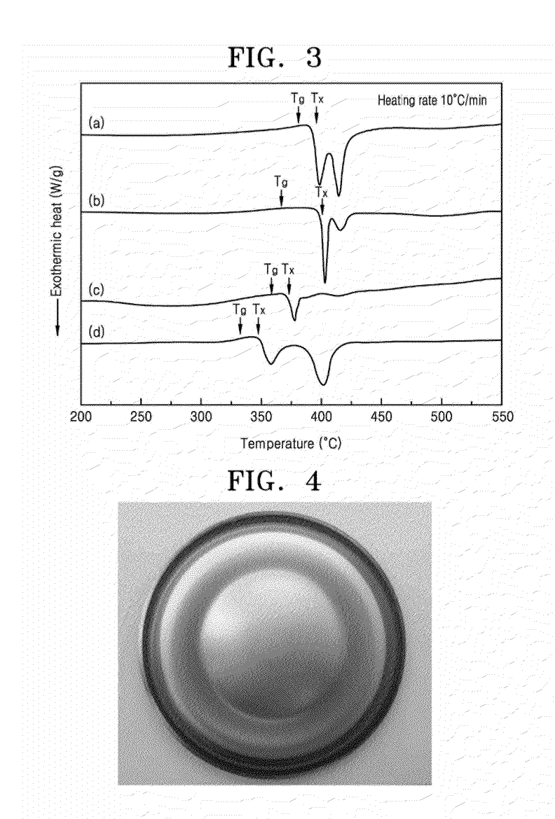

FIG. 3 (a) through (d) show DSC analysis results for crystallization properties of the embodiment 2, the embodiment 7, embodiment 13 and embodiment 15 of the present invention in Table 1, respectively.

Referring to FIG. 3 (a) through (d), a heating peak caused by the crystallization during increasing temperature was observed for the embodiment 2, the embodiment 7, the embodiment 13 and the embodiment 15 of the present invention in Table 1, respectively. Accordingly, an amorphous phase is present in the at least some portion of each of the alloys according to the embodiments of the present invention.

The Zr-group amorphous alloy composition according to the embodiments of the present invention can be used in various fields such as a semiconductor manufacturing process, a microstructure manufacturing process such as MEMS, a coating forming process for molds and vehicle parts required wear resistance. Hereinafter, as a specific example, the application of the Zr-group amorphous alloy composition to a sputtering target will be described.

In a sputtering process, high speed Ar ions or the like collide a target applied negative voltage and elements of the target is separated from the target to reach a matrix, thereby forming a thin film on a surface of the matrix. When an amorphous phase thin film or a nano-composite thin film having amorphous phases is formed by the sputtering process, an amorphous target can be used. Such a amorphous target may be made of a multi elements system metal alloy having a high amorphous forming ability. Heterogeneous metal elements from the amorphous target may form an alloy thin film having an amorphous phase on a surface of a matrix.

However, temperature of the amorphous target increases due to the collision of ions thereto during sputtering process. The temperature increase may change the structure of the target. That is, when the temperature of the target increases, the surface of the target may be locally crystallized because of the thermal instability of the amorphous phase. Such a local crystallization changes the volume of the target and relaxes the structure thereof, thereby increasing the brittleness of the target. Accordingly, the target can be easily broken during the sputtering process. When the target is broken during the process, the product production gets in significant trouble. Therefore, it is important to obtain a stable target not to be broken during the sputtering process.

According to the present invention, an alloy target for sputtering can be formed from the crystalline alloy. The crystalline alloy can be formed by preparing a plurality of the above described Zr-group amorphous alloys (or nano-crystalline alloys); and thermal pressing the plurality of the amorphous alloys (or the nano-crystalline alloys) at a temperature in the range of equal to or more than the crystallization starting temperature of the amorphous alloys (or the nano-crystalline alloys) and less than the melting temperature of the amorphous alloys (or the nano-crystalline alloys) to have the average size of crystal grains thereof in the range of, for example, 0.1 μm through 5 μm, for example, 0.1 μm through 1 μm, for example, 0.1 μm through 0.5 μm, for example, 0.3 μm through 0.5 μm. Accordingly, the alloy target for sputtering composed of the crystalline alloy has significantly increased thermal/mechanical stability, and thus the alloy target is not drastically broken during the sputtering process, thereby stably performing sputtering process. In addition, since the target has very uniform microstructure, composition difference between the target and the thin film due to the difference in sputtering yields in the target of multi element system can be significantly reduced and the uniformity of composition inside of the thin film can be obtained. For more detailed description, Korean patent Application Nos. 10-2011-0129888 and 10-2013-0065244 filed by the inventors of the present invention can be referred to.

FIG. 4 is a photograph for a target made of the amorphous alloy composition of the embodiment 2 in Table 2 according to the present invention. Referring to FIG. 4, the sputtering target was not broken during the sputtering process, and the surface of target did not show non-uniformity in compositions of the components after the sputtering process due to the difference in sputtering yields.

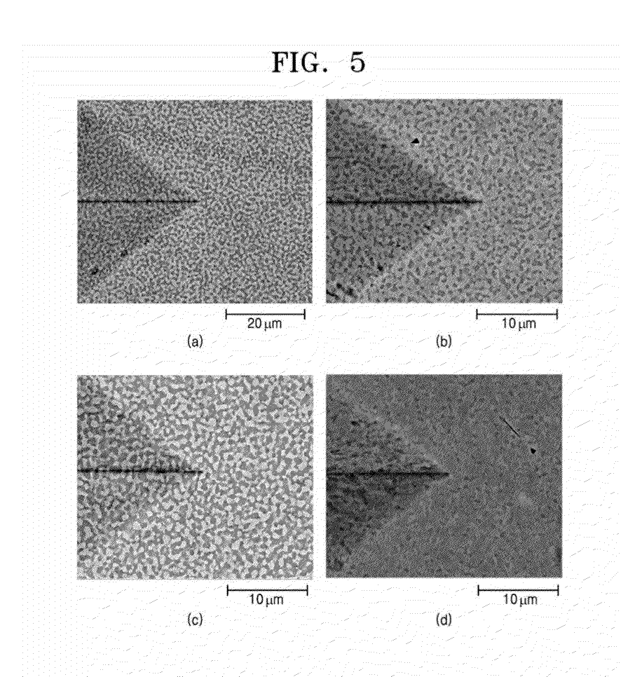

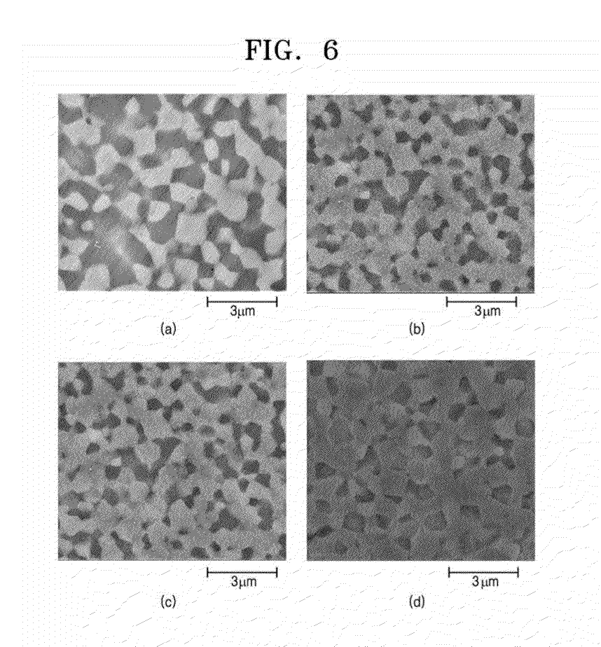

FIG. 5 shows electron microscopy observation results of regions near indentation marks after crack generation test for the Zr-group amorphous alloy compositions after annealing of the embodiment 2, the embodiment 7, the embodiment 12 and the embodiment 15 of the present invention in Table 1. FIG. 6 shows electron microscopy observation results of microstructures of crystalline alloy targets formed by the Zr-group amorphous alloy compositions of the embodiment 2, the embodiment 7, the embodiment 12 and the embodiment 15 of the present invention in Table 1.

Referring to FIG. 5 and FIG. 6, the sputtering alloy target, formed by annealing the Zr-group amorphous alloy composition of the embodiment of the present invention in Table 1 at a temperature in the range of equal to or more than the crystallization starting temperature of the amorphous alloy and less than the melting temperature of the amorphous alloy, has a crystalline structure in which crystal grains having the size in the range of 0.1 μm through about 5 μm are uniformly distributed and does not have cracks.

The Zr-group amorphous alloy composition according to the embodiments of the present invention is formed as amorphous alloy ribbons to be applied for a metal bipolar plate used in a polymer electrolyte fuel cell. Hereinafter, as a specific example, the application of the amorphous alloy ribbon to a bipolar plate will be described. A metallic bipolar plate currently used has low corrosion resistance against operation environments of fuel cells, thereby degrading the properties of the fuel cells. Accordingly, various attempts to increase corrosion resistance of a bipolar plate are performed. For example, amorphous alloy ribbons are used to form bipolar plate or an amorphous film is coated on a metallic plate. As described above, the amorphous alloy target of the present invention can be applied to coat an amorphous film on a metallic bipolar plate. As another example, amorphous ribbons formed by using the amorphous alloy of the present invention can be used to substitute stainless steel.

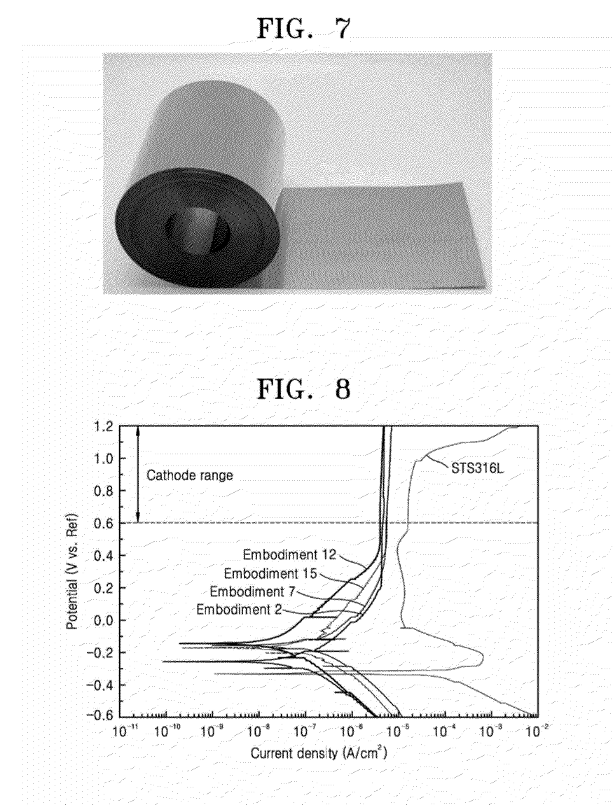

FIG. 7 is a photograph of an amorphous alloy ribbon by using amorphous alloy composition of the embodiment 15 of the present invention. FIG. 8 shows potentiodynamic polarization test results of amorphous ribbons of the embodiment 2, the embodiment 7, the embodiment 12 and the embodiment 15 of the present invention under a polymer electrolyte fuel cell stack environment. In the potentiodynamic polarization test, a mixed solution of 1M H₂SO4 and 2 ppm HF was used. The measurement potential range was −0.6 V through 1.2 V. Table 2 shows potentiodynamic polarization test results of the amorphous ribbons with respect to alloy compositions.

TABLE 2

| Alloy composition | E_{corr} (mV) | I_{corr} (A/cm2) |
|---|---|---|
| Embodiment 2 | −0.24 | 8.8E−8 |
| Embodiment 7 | −0.14 | 1.82E−7 |
| Embodiment 12 | −0.14 | 1.78E−8 |
| Embodiment 15 | −0.17 | 8.36E−8 |
| Comparative example | −0.33 | 5.60E−5 |

Referring to Table 2, the stainless steel plate currently used for a metallic bipolar plate has 5.60×10₋₅ A/cm₂ of corrosion resistance density. However, the Zr-group amorphous alloy ribbon of the present invention has 1.78×10⁻⁸ A/cm² of corrosion resistance density. Accordingly, the corrosion resistance property of the amorphous alloy ribbon of the present invention is much better than that of the stainless steel plate.

FIG. 8 shows potentiodynamic polarization test results of the amorphous alloy ribbons of the embodiment 2, the embodiment 7, the embodiment 12 and the embodiment 15 of the present invention. It was found that The stainless steel plate was corroded under 1.0 V corrosion potential, the operation environment of the fuel cell stack, due to over passivating reaction. However, the amorphous alloy ribbons according to the embodiments of the present invention was passively reacted under 0.6 V through 1.2 V corrosion potential, the operation environment of the fuel cell stack, and then was not corroded any more. Accordingly, the amorphous ribbon formed by using the amorphous alloy composition of the present invention has excellent corrosion resistance under the operation environment of the fuel cell stack.

The foregoing is illustrative of exemplary embodiments and is not to be construed as limiting thereof. Although exemplary embodiments have been described, those of ordinary skill in the art will readily appreciate that many modifications are possible in the exemplary embodiments without materially departing from the novel teachings and advantages of the exemplary embodiments. Accordingly, all such modifications are intended to be included within the scope of the claims. Exemplary embodiments are defined by the following claims, with equivalents of the claims to be included therein.

1. A Zr-group amorphous alloy composition, comprising:
67 atomic % through 78 atomic % of Zr;
4 atomic % through 13 atomic % of one or more selected from Al and Co; and
15 atomic % through 24 atomic % of one or more selected from Cu and Ni,
wherein an amorphous forming ability thereof is equal to or more than 0.5 mm.

2. The Zr-group amorphous alloy composition of claim 1, wherein the composition comprises:
67 atomic % through 78 atomic % of Zr;
4 atomic % through 12 atomic % of Co; and
15 atomic % through 24 atomic % of one or more selected from Cu and Ni.

3. The Zr-group amorphous alloy composition of claim 1, wherein the composition comprises:
67 atomic % through 78 atomic % of Zr;
3 atomic % through 10 atomic % of Al;
2 atomic % through 9 atomic % of Co; and
17 atomic % through 23 atomic % of Cu.

4. The Zr-group amorphous alloy composition of claim 1, wherein the alloy composition is capable of obtaining an amorphous ribbon having casting thickness in the range of 20 μm through 100 μm when the melt of the alloy composition is cast with a cooling rate in the range of 10⁴ K/sec through 10⁶ K/sec.

5. A bipolar plate for a fuel cell manufactured by using an amorphous ribbon having the same composition as the alloy composition of claim 1.
